(19) United States
(12) Patent Application Publication
(10) Pub. No.: US 2026/0085647 A1
(43) Pub. Date: Mar. 26, 2026

(54) PISTON

(71) Applicant: TOYOTA JIDOSHA KABUSHIKI KAISHA, Toyota-shi (JP)

(72) Inventor: Takanori NAKANO, Okazaki-shi (JP)

(73) Assignee: TOYOTA JIDOSHA KABUSHIKI KAISHA, Toyota-shi (JP)

(21) Appl. No.: 19/190,983

(22) Filed: Apr. 28, 2025

(30) Foreign Application Priority Data
Sep. 20, 2024 (JP) 2024-163940

(51) Int. Cl. F02F 3/02

(52) U.S. Cl. CPC F02F 3/02

(57) ABSTRACT

The present disclosure relates to a piston. The piston is provided in a cylinder of the internal combustion engine. A thermal barrier film is formed on the top face of the piston. The thermal barrier film includes a first portion and a second portion that is thinner than the first portion.

### CROSS-REFERENCE TO RELATED APPLICATION

This application claims priority to Japanese Patent Application No. 2024-163940 filed on Sep. 20, 2024. The disclosure of the above-identified application, including the specification, drawings, and claims, is incorporated by reference herein in its entirety.

### BACKGROUND

### 1. Technical Field

The present disclosure relates to a piston that is provided in an internal combustion engine.

### 2. Description of Related Art

As disclosed in Japanese Unexamined Patent Application Publication No. 2017-66995 (JP 2017-66995 A), a piston is provided in a cylinder of an internal combustion engine, and also a combustion chamber is partitioned by the piston. That is to say, a top face of the piston faces the combustion chamber. In order to suppress transfer of heat from the combustion chamber to the piston, a thermal barrier film is formed on the top face of the piston.

### SUMMARY

Coefficients of linear thermal expansion are different between component members of the piston and material of the thermal barrier film. Accordingly, stress caused by difference in amount of thermal expansion and amount of shrinkage between the piston and the thermal barrier film is applied to the thermal barrier film. Also, a load caused by in-cylinder pressure, which is pressure in the cylinder in which the piston is provided, is applied to the thermal barrier film. During operation of the internal combustion engine, the in-cylinder pressure fluctuates greatly. Thus, the greater stress amplitude, which is an amplitude of fluctuation of the load, a greater load will act on the thermal barrier film. Accordingly, when the internal combustion engine is used over extended periods of time, there is a likelihood that cracks will form in the thermal barrier film. Depending on positions where the cracks are formed, there is a likelihood that the effect of suppressing the transfer of heat from the combustion chamber to the piston will decrease significantly.

A piston for solving the above problem is provided in a cylinder of an internal combustion engine. The piston includes a thermal barrier film that is provided on a top face of the piston. The thermal barrier film is made up of a first portion and a second portion that is thinner than the first portion.

The piston has an effect of being able to control portions where cracks form in the thermal barrier film that is provided on the top face thereof.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of an internal combustion engine including a piston according to an embodiment;

FIG. 2 is a top view of the piston of FIG. 1;

FIG. 3 is a cross-sectional view taken along line 3-3 in FIG. 2; and

FIG. 4 is an operation diagram showing a state in which a crack is generated in the thermal barrier film.

### DETAILED DESCRIPTION OF EMBODIMENTS

### Configuration of Internal Combustion Engine

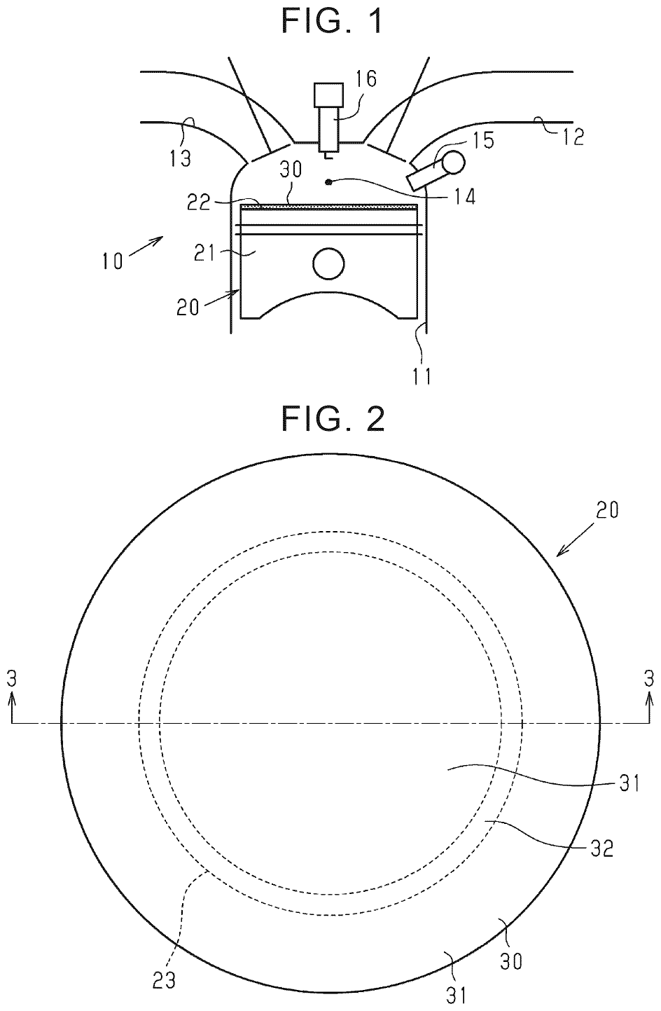

Hereinafter, an embodiment of a piston will be described with reference to FIGS. 1 to 4. FIG. 1 shows an internal combustion engine 10 with a piston 20 of the present embodiment. The internal combustion engine 10 further includes a plurality of cylinders 11, an intake passage 12, and an exhaust passage 13. In FIG. 1, only one of the plurality of cylinders 11 is illustrated. A combustion chamber 14 is defined in the plurality of cylinders 11 by a piston 20. Further, a fuel injection valve 15 and an ignition plug 16 are provided for each of the plurality of cylinders 11.

Air is introduced into the combustion chamber 14 through the intake passage 12. The fuel injected from the fuel injection valve 15 is supplied to the combustion chamber 14. In the combustion chamber 14, the air-fuel mixture is burned by the spark discharge of the ignition plug 16. The exhaust gas generated in the combustion chamber 14 by the combustion of the air-fuel mixture is discharged to the exhaust passage 13.

### Piston Configuration

As illustrated in FIG. 1, the piston 20 includes a piston body 21 made of a metal material and a thermal barrier film 30. The piston body 21 has a top face 22 facing the combustion chamber 14.

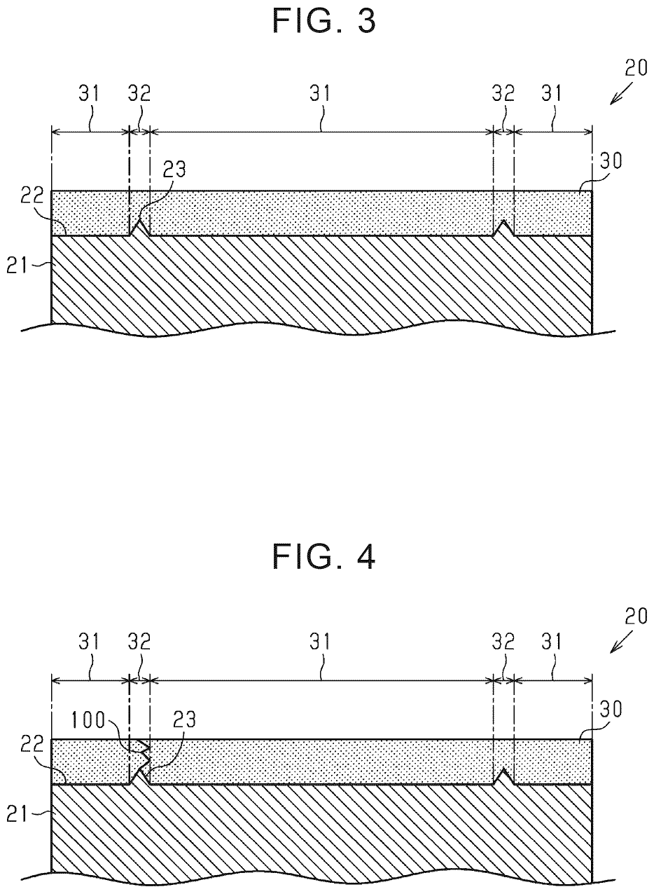

As shown in FIGS. 2 and 3, a protruding portion 23 is provided on the top face 22. The protruding portion 23 has an annular shape so as to surround the middle of the top face 22.

The thermal barrier film 30 is a thin film provided on the top face 22. The thermal barrier film 30 is a film for suppressing the transfer of heat from the combustion chamber 14 to the piston 20. As shown in FIG. 3, the protruding portion 23 is covered with the thermal barrier film 30.

The thermal barrier film 30 includes a first portion 31 and a second portion 32 that is thinner than the first portion 31. The second portion 32 is provided on the protruding portion 23. Therefore, the second portion 32 is provided so as to surround the middle of the top face 22. In the thermal barrier film 30, each of a portion inside the second portion 32 and a portion outside the second portion 32 is a first portion 31.

### Operation of this Embodiment

The operation of the present embodiment will be described with reference to FIG. 4.

In the combustion stroke of the internal combustion engine 10, the thermal barrier film 30 is exposed to a high temperature. On the other hand, the temperature rise of the piston body 21 is relatively suppressed by the heat insulating action of the thermal barrier film 30. Further, the coefficient of linear thermal expansion of the constituent material of the piston body 21 and the constituent material of the thermal barrier film 30 is different. Therefore, the compressive stress caused by the difference in the amount of thermal expansion between the piston body 21 and the thermal barrier film 30 acts on the thermal barrier film 30.

Since the thermal barrier film 30 is a thin film, the heat capacity of the piston 20 is larger than that of the thermal barrier film 30. Therefore, in the intake stroke of the internal combustion engine 10, the temperature of the piston 20 is higher than that of the thermal barrier film 30. As a result, a tensile stress acts on the thermal barrier film 30.

That is, during the operation of the internal combustion engine 10, the period in which the compressive stress acts on the thermal barrier film 30 and the period in which the tensile stress acts on the thermal barrier film 30 are alternately repeated. Therefore, cracks 100 are likely to occur in the thermal barrier film 30.

In addition, a load caused by the in-cylinder pressure, which is the pressure in the cylinder 11, is applied to the thermal barrier film 30. The load applied to the thermal barrier film 30 varies. The larger the stress amplitude, which is the amplitude of the fluctuation of the load, the more easily the thermal barrier film 30 is damaged.

In the thermal barrier film, the above-described cracks are likely to occur in the fragile portion. The thin portion is weaker than the thick portion. Therefore, cracks are more likely to occur in the thinner portion than in the thicker portion.

In this regard, the thermal barrier film 30 of the piston 20 includes not only the first portion 31 but also a second portion 32 that is thinner than the first portion 31. That is, as shown in FIG. 4, in the thermal barrier film 30, cracks 100 are more likely to occur in the second portion 32 than in the first portion 31. Therefore, in the piston 20 of the present embodiment, the occurrence of the crack 100 in the first portion 31 is suppressed.

### Effect of This Embodiment

(1) When the crack 100 occurs in the piston 20 of the present embodiment, the crack 100 is more likely to occur in the second portion 32 than in the first portion 31. Therefore, in the piston 20, it is possible to control the position where the crack 100 is generated.

(2) In the piston 20, the middle portion becomes the highest temperature. Heat is transferred from the hot portion to the cold portion. Therefore, when the crack 100 is generated in the middle portion of the piston 20, the heat shielding property by the thermal barrier film 30 is greatly deteriorated.

In this regard, in the present embodiment, as shown in FIG. 2, the second portion 32 is provided so as to surround the middle of the top face 22. Therefore, cracks 100 are less likely to occur in the thermal barrier film 30 at the middle portion of the piston 20. Therefore, in the piston 20, even if the crack 100 is generated in the thermal barrier film 30, it is possible to prevent the heat shield characteristics of the thermal barrier film 30 from being significantly deteriorated.

### Example of Change

The above-described embodiment can be modified as follows. The above-described embodiments and the following modifications can be implemented in combination with each other as long as they are not technically contradictory.
If the thermal barrier film 30 including the first portion 31 and the second portion 32 can be formed on the top face 22, the protruding portion 23 may not be provided on the top face 22.
The second portion 32 may not be annular as long as it has an annular shape.
The second portion 32 may not be annular as long as it surrounds the middle of the piston 20.

What is claimed is:

1. A piston that is provided in a cylinder of an internal combustion engine, the piston comprising: a thermal barrier film that is provided on a top face of the piston, wherein the thermal barrier film is made up of a first portion and a second portion that is thinner than the first portion.

2. The piston according to claim 1, wherein
the second portion is provided surrounding a middle of the top face, and
in the thermal barrier film, each of a portion on an inner side from the second portion, and a portion on an outer side from the second portion, is the first portion.

3. The piston according to claim 2, wherein the second portion is annular in shape.

4. The piston according to claim 1, wherein a protruding portion is provided on the top face, and the second portion is provided on the protruding portion.
